(19) United States
(12) Patent Application Publication
(10) Pub. No.: US 2010/0125483 A1
(43) Pub. Date: May 20, 2010

(54) Method and Apparatus to Facilitate Using a Highest Level of a Hierarchical Task Model To Facilitate Correlating End User Input With a Corresponding Meaning

(75) Inventors: Paul C. Davis, Arlington Heights, IL (US); William K. Thompson, Evanston, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/274,921

(22) Filed: Nov. 20, 2008

(51) Int. Cl. G06Q 10/00

(52) U.S. Cl. 705/9

(57) ABSTRACT

One receives input (101) from a given end user as pertains to a particular task to be executed and automatically accesses (102) a hierarchical task model as corresponds to a particular task to be executed by a given end user to thereby identify one or more presently un-executed agenda elements. One also automatically accesses (103) characterizing information for that given end user. (By one approach, for example, this characterizing information can comprise information regarding the given end user's knowledge.) This information regarding the un-executed agenda elements and the characterizing information are then used (104) to identify a highest hierarchical level within the hierarchical task model as corresponds to the given end user's wherewithal to successfully execute without also needing lower hierarchical level content within the hierarchical task model. This hierarchical level is then used (105) to facilitate correlating the input with a corresponding meaning.

### RELATED APPLICATION(S)

This application is related to co-pending and co-owned U.S. patent application Ser. No. ______ (bearing attorney's docket number CML06943 (7303/92857), entitled METHOD AND APPARATUS TO FACILITATE USING A HIERARCHICAL TASK MODEL WITH RESPECT TO CORRESPONDING END USERS and filed on even date herewith, which is incorporated by reference in its entirety herein.

### TECHNICAL FIELD

This invention relates generally to task facilitation and to hierarchical models.

### BACKGROUND

Task facilitation is known in the art. This generally comprises mechanisms and/or processes that assist with executing a particular task by one or more end users. Hierarchical models are also known in the art. Hierarchical models have contents organized into a tree-like structure. Such hierarchical models are a useful construct and have been used, for example, to model the various steps or sub-tasks that collectively comprise a particular task.

Task facilitation generally presumes and requires an end user interface. This provides a basis for interacting with the end user to permit, for example, receiving input such as instructions or information from the end user that is useful or necessary with respect to executing the task. This also provides a basis for providing content to the end user as pertains to the state of the task execution process, instructions, and so forth. Generally speaking, the use of an end user interface in conjunction with a task facilitation process is a powerful paradigm that can greatly increase efficiency, accuracy, and user satisfaction.

End user interfaces necessarily tend, by design, to accommodate the wherewithal of an expected user group. (As used herein, the expression “wherewithal” will be understood to refer to the ability of a given individual to accomplish a particular activity. This can comprise a reference to that individual's physical abilities as well as their level of experience, their knowledge base, and their cognitive capabilities. This can also comprise a reference to that individual's ready access to non-native resources such as tools, data and information sources, and so forth.) When presumptions regarding the average wherewithal of the anticipated user group are relatively high or low as compared to the actual wherewithal of a given end user, this can result in received end user input that is potentially difficult to interpret.

For example, when a given end user's wherewithal is relatively low, that end user's input may be difficult to interpret because the implementing platform is configured to operate presuming a relatively higher level of interchange. Similarly, when a given end user's wherewithal is relatively high, that end user's input can again be difficult to interpret because the implementing platform is configured to operate presuming a relatively lower level of interchange. In either case, such circumstances can give rise to confusion, error, delay, and other problems that can ultimately lead to end-user dissatisfaction and/or failure to effect the desired task.

### BRIEF DESCRIPTION OF THE DRAWINGS

The above needs are at least partially met through provision of the method and apparatus to facilitate using a highest hierarchical level to facilitate correlating end user input with a corresponding meaning described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a schematic representation as configured in accordance with various embodiments of the invention;

FIG. 4 comprises a flow diagram as configured in accordance with various embodiments of the invention;

FIG. 5 comprises a block diagram as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one receives input from a given end user as pertains to a particular task to be executed (at least in part) by that given end user. These teachings also provide for automatically accessing a hierarchical task model as corresponds to a particular task to be executed by a given end user to thereby identify one or more presently un-executed agenda elements. One also automatically accesses characterizing information for that given end user. (By one approach, for example, this characterizing information can comprise information regarding the given end user's knowledge.) This information regarding the un-executed agenda elements and the characterizing information are then used to identify a highest hierarchical level within the hierarchical task model as corresponds to the given end user's wherewithal to successfully execute without also needing lower hierarchical level content within the hierarchical task model. These teachings then provide for using this highest hierarchical level to facilitate correlating the aforementioned input from the given end user with a corresponding meaning.

Put simply, these steps can aid in identifying a level of participation at which the end user is likely to usefully accommodate when executing the task at hand. This, in turn, permits the inputs being received from this end user to be more likely correctly interpreted and acted upon by helping to steer the interpretation of that input as a function of the foregoing information.

By one approach, this step of correlating the end user input with a corresponding meaning can occur during execution of the particular task at hand. By this approach, the resultant gleaned meaning can serve in an active manner to facilitate the completion of the task. By another approach, however, this step can occur subsequent to execution of the particular task. This can be useful, for example, when forming an archival record of some or all of the task-execution activities.

By one approach, these teachings will accommodate correlating the input from the end user with a corresponding semantically-expressed meaning. The latter can be useful, for example, in a natural-language application setting and/or when employed in a manner that necessarily (or usefully) includes sharing the end user's input with one or more other end users who may also be participating in (or at least observing) the execution of the task. These teachings will also accommodate, if desired, correlating the input from the end user with a corresponding meaning that is end-user neutral.

In some application settings a plurality of end users are cooperating (either directly or indirectly and knowingly or unknowingly) with one another to execute an overall task. This can comprise, for example, different individuals each executing respective corresponding sub-tasks as appropriate to their role, authority, access to information, or the like. The present teachings are readily leveraged in such an application setting by using the aforementioned corresponding meaning to facilitate presenting the end user input to another end user who is also participating in execution of the particular task.

Those skilled in the art will recognize and appreciate that these teachings comprise a powerful and readily leveraged approach that will accommodate a wide range of tasks and application setting needs, requirements, and/or opportunities. It will further be recognized that these teachings are highly scalable and can be employed with essentially any number of potential or actual end users. By potentially ensuring that essentially all end users are able to effectively provide their inputs to the task-execution process at hand essentially regardless of their relative wherewithal to effect that task (or various sub-tasks as comprise that task), these teachings aid in ensuring that all end users are able to successfully complete their task-relevant assignments in a manner that prompts both efficiency as well as accuracy and completeness.

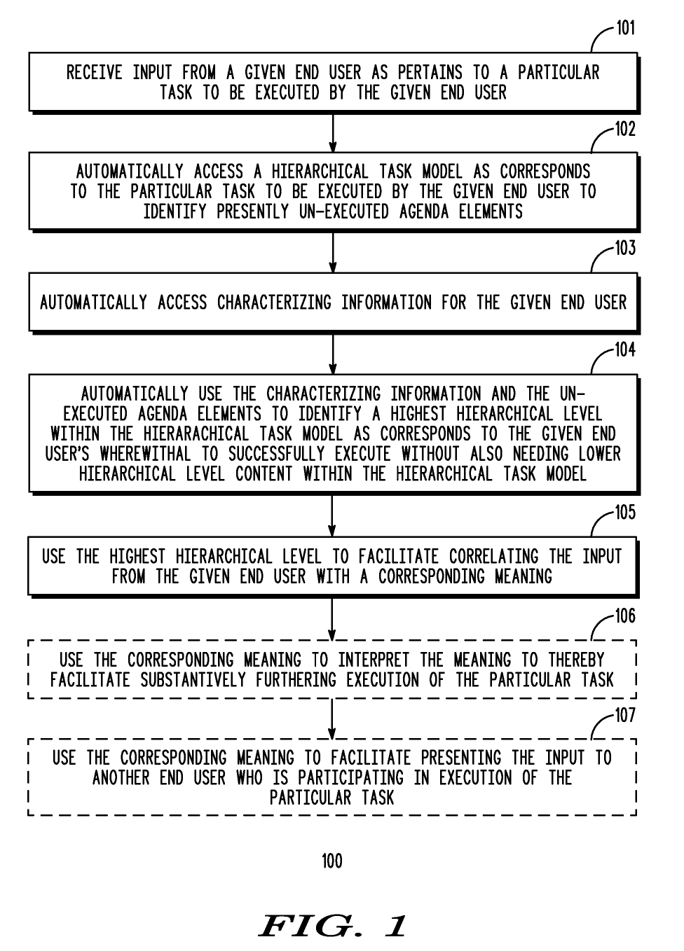

These and other benefits may become clearer upon making a thorough review and study of the following detailed description. Referring now to the drawings, and in particular to FIG. 1, an illustrative process that is compatible with many of these teachings will now be presented.

This process 100 provides the step 101 of receiving input from a given end user as pertains to a particular task to be executed, at least in part, by a given end user. The precise nature, substance, and form of this input can vary widely from one application setting to another as will be well understood by those skilled in the art. As a simple example in this regard, the form of the input can vary as a function of the modality of the user interface by which this process receives this input. Various approaches are known in the art in this regard. As these teachings are not overly sensitive to any particular selection in this regard, for the sake of brevity and the preservation of clarity, further elaboration in this regard will not be presented here.

This process 100 then provides for the step 102 of automatically accessing a hierarchical task model as corresponds to a particular task to be executed by a given end user to thereby identify presently un-executed agenda elements. As used herein, the expression “agenda elements” will be understood to comprise the discrete steps, actions, or sub-tasks to be undertaken and completed by the given end user which, in the aggregate, constitute the things that need to occur in order to effect the execution of a corresponding task. Agenda elements can include, but are certainly not limited to, data input opportunities or requirements, authorization entry, and any of a wide variety of real-world physical activities, to note but a few examples in this regard. It will be understood by those skilled in the art that these teachings are applicable to a single task which is to be executed by a single given end user and are also applicable to a single task that is to be executed by a plurality of end users as appropriate to the needs and/or opportunities as tend to characterize the application setting.

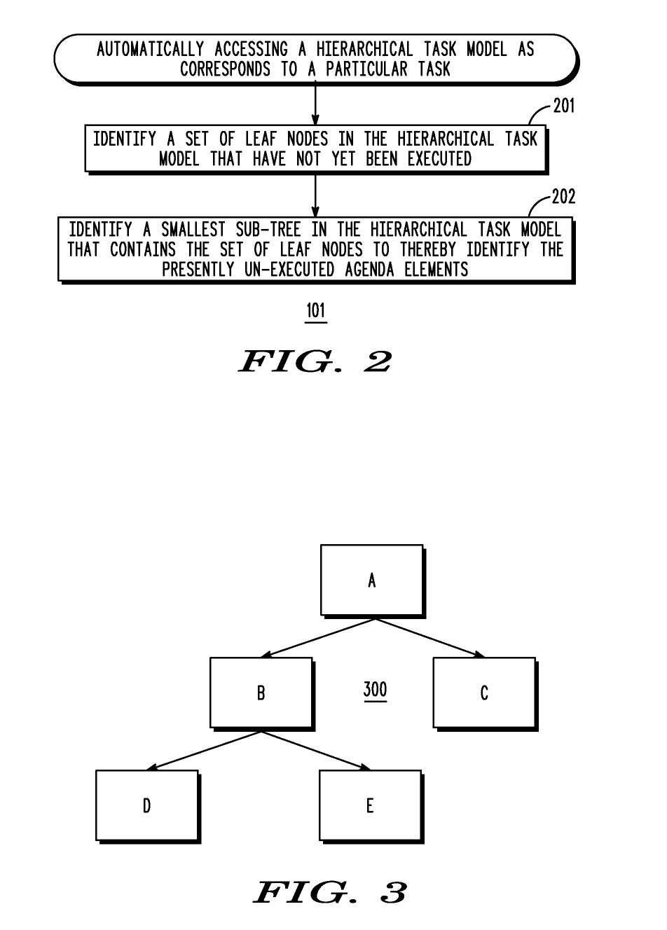

This step 102 can be carried out in any of a variety of ways. By one approach, and referring momentarily now to FIG. 2, this step 101 can comprise the step 201 of identifying a set of leaf nodes in the hierarchical task model that have not yet been executed followed by the step 202 of identifying a smallest sub-tree in the hierarchical task model that contains the set of leaf nodes to thereby identify the presently un-executed agenda elements. Referring momentarily to FIG. 3, which provides a greatly simplified illustrative schematic representation of a hierarchical task model 300, this might comprise identifying leaf nodes D and E when the agenda element(s) represented by leaf node C has already been executed. In these same regards, it may be worth noting as well that the smallest sub-tree that contains these leaf nodes is the one rooted at node B, as node B covers nodes D and E and no other leaf nodes.

This step 102 can be carried out in a manner that corresponds to the limits and/or opportunities of a given application setting. For example, this may comprise accessing a hierarchical task model as stored (in whole or in part) in a local memory (that is, in a memory that comprises a part of a same discrete processing platform as contains, for example, a processor that is effecting this step 102). By another approach, however, this step can comprise accessing a hierarchical task model that is stored in a remote memory. (As used herein, the expression “remote” will be understood to refer to either a significant physical separation (as when two objects are each physically located in discrete, separate, physically separated facilities such as two separate buildings or further) or a significant administrative separation (as when two objects are each administered and controlled by discrete, legally, and operatively separate entities).) Such architecturally-based possibilities are well understood by those skilled in the art and require no further elaboration here.

Referring again to FIG. 1, this process 100 also provides the step 103 of automatically accessing characterizing information for the given end user. Generally speaking, this characterizing information will tend to reflect, directly or indirectly, upon the wherewithal of the given end user to execute the particular task (and/or particular agenda elements as comprise that task). By one approach, for example, this can comprise information regarding the given end user's knowledge (i.e., knowledge that is relevant to the aforementioned task/agenda element execution). This can range from objective information (such as information regarding academic degrees held by the end user, technical training certificates (including both third party and in-house-based recognition), awards, publications, speaking event agendas, number of years in a particular role, and so forth) to subjective information (such as information reflecting supervisory reviews, peer reviews, resumes, and so forth), to self-identification or assessment from a user, or to system inferences based on usage patterns and behavior, and so forth.

As with the hierarchical task model itself, this characterizing information can be accessed using a local and/or a remotely located storage media as desired.

As described, these steps can be carried out for a single given end user. When there are a plurality of end users involved with executing the task, these teachings will of course accommodate accessing such information for all of these end users and/or for some selected sub-grouping as desired.

This process 100 then provides the step 104 of automatically using this characterizing information and the information regarding the un-executed agenda elements to identify a highest hierarchical level within the hierarchical task model as corresponds to the given end user's wherewithal to successfully execute without also needing lower hierarchical level content within the hierarchical task model. In effect, to put it perhaps more simply, by this step 104 this process 100 identifies a particular highest level within the hierarchical task model that corresponds to an activity that the end user can accomplish without the benefit of being led through (or informed about) sub-activities that may comprise, or lead up to, this particular activity.

To provide a very simple example in these regards, and without intending any limitations in these regards, consider a task that comprises effecting a purchase of a selected item via a web browser. Pursuant to these teachings, this step 104 might comprise identifying, for a very experienced shopper, a level that corresponds to the generalized task of entering their shipping information. This same step 104, however, for an inexperienced shopper, might identify instead a plurality of levels (lower than the aforementioned level in the hierarchical scheme) that comprise the agenda elements representing the atomic sub-tasks of the generalized task of entering such shipping information. These atomic sub-tasks might comprise, for example, “Enter Your Street Address,” “Enter Your City,” “Enter Your State,” “Enter Your Postal Code,” and so forth.

This resultant information regarding the highest hierarchical level can then be used, as exemplified in step 105, to facilitate correlating the input from the given end user with a corresponding meaning. In many application settings, for example, this can comprise using the highest hierarchical level to facilitate correlating the input from the given end user with a corresponding meaning during execution of the particular task. This process 100 will also support, however, using the highest hierarchical level to facilitate correlating the input from the given end user with a corresponding meaning subsequent to execution of the particular task. In the latter case, for example, this corresponding meaning may be used to form an archival record that comprises, at least in part, this corresponding meaning.

In many cases, this step 105 will comprise using the highest hierarchical level to facilitate correlating the input from the given end user with a corresponding semantically-expressed meaning. In this case, for example, the input (regardless of the form or modality of its original expression by the given end user) can be rendered as natural-language phrases, expressions, or sentences in a human language of choice that express the assessed meaning. These teachings will also support, however, using the highest hierarchal level to facilitate correlating the input with a corresponding meaning that is end-user neutral. (As used herein, the expression “end-user neutral” will be understood to refer to a mode of expression that is not dependent upon the end user being familiar with a given human language, a given one or more expressions of highly specialized and technical jargon, a particular set of coded expressions, or the like.)

This process 100 will then optionally support, as desired, any of a variety of uses of this corresponding meaning. As one example in this regard, this process 100 will optionally support a step 106 that provides for using the corresponding meaning to interpret the meaning to thereby facilitate substantively furthering execution of the particular task. For example, using the simple case described previously where a shipping address is given, a system can interpret the corresponding meaning and then record the address and take any next required steps to complete the overall shopping task. The resultant system action in this shipping address entry example would be the same even for users who had different levels of sophistication and familiarity, thus one user might input a complete set of detail regarding the shipping address while another person more familiar with the system might simply say “home.”

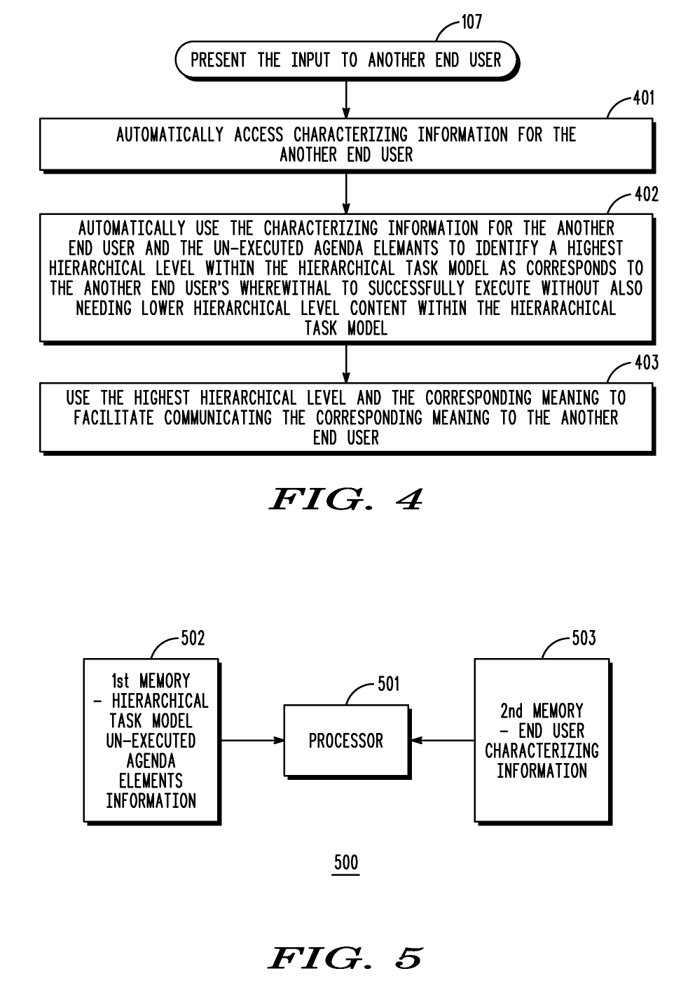

As another example in this regard, and with continued reference to FIG. 1, this process 100 will optionally accommodate a step 107 wherein using the corresponding meaning to facilitate presenting the input to another end user who is participating in execution of the particular task. This, again, can be realized in any of a variety of ways. As one illustrative example in this regard, and referring now to FIG. 4, such a step 107 can comprise the step 401 of automatically accessing characterizing information for this another end user. This characterizing information can be of the same kinds as those that were described above.

Another corresponding step 402 can comprise automatically using this characterizing information for the another end user as well as the previously mentioned un-executed agenda elements to identify a highest hierarchical level within the hierarchical task model as corresponds to this another end user's wherewithal to successfully execute without also needing lower hierarchical level content within the hierarchical task model. This step, too, can be carried out in a manner similar to that described above for the initial given end user if desired. A following step 403 can then provide for using this highest hierarchical level and the corresponding meaning (as was earlier developed for the given end user) to facilitate communicating the corresponding meaning to the another end user. This step of communicating this meaning to the another end user can be taken, for example, to substantively further the execution of the particular task at hand.

Continuing with the shopping scenario described earlier, this behavior can be illustrated by considering a first user, who is unfamiliar with the system and who must therefore input all shipping information in detail, and a second user who is familiar with the system and who is monitoring the first user's task completion state. When the first user completes entering their home shipping address, the system can reflect this communication to the second user at the second user's appropriate level by telling the second user that the first user has entered their home address, or alternatively that the first user has completed the shipping address entry, rather than displaying the entire first user address entry. An additional example of this type of technique in the same scenario would be to show status messages to the second user. This might comprise, for example, showing a shipping information progress bar to the second user and the corresponding state of completion as the first user fills in fields.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

In this illustrative example, the enabling platform 500 comprises a processor 501 that operably couples to a first memory 502 and a second memory 503. This first memory 502 can have the aforementioned information regarding the presently un-executed agenda elements of the aforementioned hierarchical task model as corresponds to a particular task that is to be executed by a given end user stored therein. The second memory 503, in turn, can have the aforementioned characterizing information for this given end user stored therein.

Those skilled in the art will recognize and appreciate that such a processor 501 can comprise a fixed-purpose hard-wired platform or can comprise a partially or wholly programmable platform (such as a microprocessor, a microcontroller, or some other digital computer of choice). All of these architectural options are well known and understood in the art and require no further description here. This processor 501 can be configured (using, for example, corresponding programming as will be well understood by those skilled in the art) to carry out one or more of the steps, actions, and/or functionality as has been described herein. This can comprise, for example, programming the processor 501 to receive input from a given end user as pertains to a particular task to be executed and to automatically use the characterizing information and the un-executed agenda elements to identify a highest hierarchical level within the hierarchical task model as corresponds to the given end user's wherewithal to successfully execute without also needing lower hierarchical level content within the hierarchical task model. This can further comprise, as desired, automatically using this highest hierarchical level to facilitate correlating the input from the given end user with a corresponding meaning.

Those skilled in the art will recognize and understand that such an apparatus 500 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art.

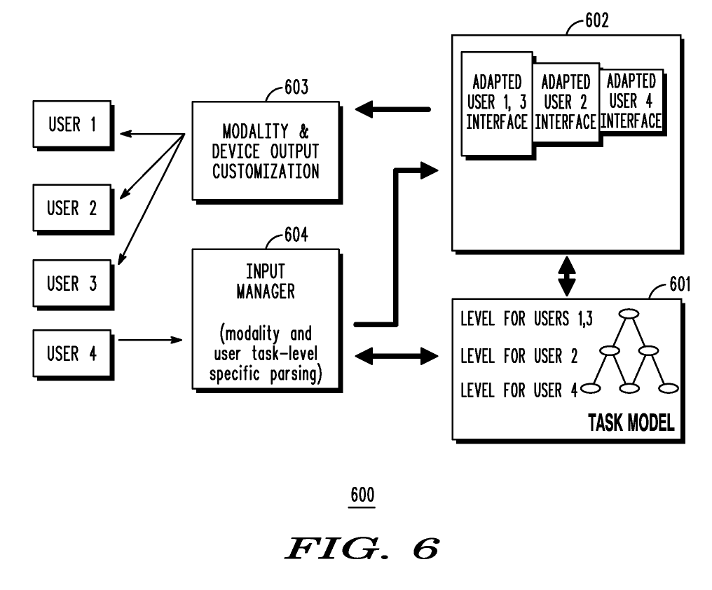

Referring now to FIG. 6, a somewhat more detailed description of an apparatus that comports with these teachings will be provided. In this particular illustrative example, the apparatus 600 is operating in conjunction with four different users (User 1 through User 4), where at least two of these users have differing levels of wherewithal to execute a given task to which all are dedicated to executing. As per these teachings, an assessment of these different levels of wherewithal in conjunction with the use of a hierarchical task model for the task to be executed yields an identification of which levels within that task model are appropriate to each such individual at any given moment during the execution of the task. This identification information is contained in a memory 601 and, in this case, indicates that User 1 and User 3, having a relatively higher level of wherewithal, are associated with a relatively high level within that task model, while User 2 (having a medium level of wherewithal) is associated with a medium task model level and User 4 (having a lowest level of wherewithal) is associated with a lowest relative level within that task model.

In this illustrative example, an interaction manager 602 uses the aforementioned information to determine the substance of a presentation to be offered to each of these four users. For example, Users 1 and 3, having been associated with a relatively high level in the task model, can be provided with relatively high level content as corresponds to this level. Meanwhile, User 4, who was associated with a relatively low level in the task model, can be provided with a correspondingly greater amount of task-facilitation content. This can vary with the application setting and the task, of course, with examples comprising a presentation of a greater quantity of explanatory material and/or a presentation of a series of sub-tasks that essentially walk this end user, step by step, through the individual activities that will lead to the accomplishment of this activity.

This illustrative embodiment also comprises a modality and device customization component 603 that receives the substantive content of the interaction manager 602 and selects a particular rendering of that content to suit the particular presentation modality as corresponds to the task-facilitation platform for each of the users.

This embodiment also includes an input manager 604 that serves to receive the inputs from the various users as they interact with this platform to facilitate the task at issue. By one approach, this input manager 604 can comprise a processor such as the one described above that has been programmed to carry out one or more of the specific steps described herein via its access to the incoming inputs from the Users along with access to the task model-based information as pertains to these various users.

Those skilled in the art will recognize and appreciate that these teachings are readily leveraged to accommodate a wide variety of task-facilitation platforms and processes. These teachings are also highly scalable and can be employed in conjunction with a wide variety and range of tasks including tasks that comprise anything from a relatively small number of constituent sub-tasks to those that require a relatively large number of such sub-tasks. It will also be understood that these teachings will accommodate and support as little or as much granularity as regards the wherewithal characterizations of the end users themselves and/or variations in presentation modality as may be desired to meet the needs and/or opportunities of a given application setting.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving input from a given end user as pertains to a particular task to be executed, at least in part, by the given end user;
automatically accessing a hierarchical task model as corresponds to the particular task to be executed by the given end user to identify presently un-executed agenda elements;
automatically accessing characterizing information for the given end user;
automatically using the characterizing information and the un-executed agenda elements to identify a highest hierarchical level within the hierarchical task model as corresponds to the given end user's wherewithal to successfully execute without also needing lower hierarchical level content within the hierarchical task model;
using the highest hierarchical level to facilitate correlating the input from the given end user with a corresponding meaning.

2. The method of claim 1 wherein automatically accessing a hierarchical task model as corresponds to a particular task to be executed by a given end user to identify presently un-executed agenda elements comprises, at least in part:
identifying a set of leaf nodes in the hierarchical task model that have not yet been executed;
identifying a smallest sub-tree in the hierarchical task model that contains the set of leaf nodes to thereby identify the presently un-executed agenda elements.

3. The method of claim 1 wherein the characterizing information for the given end user comprises information regarding the given end user's knowledge.

4. The method of claim 1 further comprising:
using the corresponding meaning to interpret the meaning to thereby facilitate substantively furthering execution of the particular task.

5. The method of claim 1 further comprising:
using the corresponding meaning to facilitate presenting the input to another end user who is participating in execution of the particular task.

6. The method of claim 5 wherein using the corresponding meaning to facilitate presenting the input to another end user who is participating in execution of the particular task comprises:
automatically accessing characterizing information for the another end user;
automatically using the characterizing information for the another end user and the un-executed agenda elements to identify a highest hierarchical level within the hierarchical task model as corresponds to the another end user's wherewithal to successfully execute without also needing lower hierarchical level content within the hierarchical task model;
using the highest hierarchical level and the corresponding meaning to facilitate communicating the corresponding meaning to the another end user.

7. The method of claim 6 wherein using the highest hierarchical level and the corresponding meaning to facilitate communicating the corresponding meaning to the another end user comprises using the highest hierarchical level and the corresponding meaning to facilitate communicating the corresponding meaning to the another end user prior to substantively furthering execution of the particular task.

8. The method of claim 1 wherein using the highest hierarchical level to facilitate correlating the input from the given end user with a corresponding meaning comprises using the highest hierarchical level to facilitate correlating the input from the given end user with a corresponding meaning during execution of the particular task.

9. The method of claim 8 wherein using the highest hierarchical level to facilitate correlating the input from the given end user with a corresponding meaning comprises also using the highest hierarchical level to facilitate correlating the input from the given end user with a corresponding meaning subsequent to execution of the particular task.

10. The method of claim 9 further comprising:
using the corresponding meaning that is derived subsequent to execution of the particular task to form an archival record that comprises, at least in part, the corresponding meaning.

11. The method of claim 1 wherein using the highest hierarchical level to facilitate correlating the input from the given end user with a corresponding meaning comprises using the highest hierarchical level to facilitate correlating the input from the given end user with a corresponding semantically-expressed meaning.

12. The method of claim 1 wherein using the highest hierarchical level to facilitate correlating the input from the given end user with a corresponding meaning comprises using the highest hierarchical level to facilitate correlating the input from the given end user with a corresponding meaning that is end user neutral.

13. An apparatus comprising:
a first memory having stored therein information comprising presently un-executed agenda elements of a hierarchical task model as corresponds to a particular task to be executed by a given end user;
a second memory having stored therein characterizing information for the given end user;
a processor that is operably coupled to the first memory and the second memory and that is configured to:
receive input from the given end user as pertains to the particular task to be executed;
automatically access the hierarchical task model to identify presently un-executed agenda elements;
automatically access the characterizing information for the given end user;
automatically use the characterizing information and the un-executed agenda elements to identify a highest hierarchical level within the hierarchical task model as corresponds to the given end user's wherewithal to successfully execute without also needing lower hierarchical level content within the hierarchical task model;
use the highest hierarchical level to facilitate correlating the input from the given end user with a corresponding meaning.

14. The apparatus of claim 13 wherein the processor is further configured to use the corresponding meaning to interpret the meaning to thereby facilitate substantively furthering execution of the particular task.

15. The apparatus of claim 13 wherein the processor is further configured to use the corresponding meaning to facilitate presenting the input to another end user who is participating in execution of the particular task.

16. The apparatus of claim 15 wherein the processor is further configured to use the corresponding meaning to facilitate presenting the input to another end user who is participating in execution of the particular task by:
automatically accessing characterizing information for the another end user;
automatically using the characterizing information for the another end user and the un-executed agenda elements to identify a highest hierarchical level within the hierarchical task model as corresponds to the another end user's wherewithal to successfully execute without also needing lower hierarchical level content within the hierarchical task model;
using the highest hierarchical level and the corresponding meaning to facilitate communicating the corresponding meaning to the another end user.

17. The apparatus of claim 16 wherein the processor is further configured to use the highest hierarchical level and the corresponding meaning to facilitate communicating the corresponding meaning to the another end user by using the highest hierarchical level and the corresponding meaning to facilitate communicating the corresponding meaning to the another end user prior to substantively furthering execution of the particular task.

18. The apparatus of claim 13 wherein the processor is further configured to use the highest hierarchical level to facilitate correlating the input from the given end user with a corresponding meaning by using the highest hierarchical level to facilitate correlating the input from the given end user with a corresponding meaning during execution of the particular task.

19. The apparatus of claim 18 wherein the processor is further configured to use the highest hierarchical level to facilitate correlating the input from the given end user with a corresponding meaning by also using the highest hierarchical level to facilitate correlating the input from the given end user with a corresponding meaning subsequent to execution of the particular task.

20. The apparatus of claim 19 wherein the processor is further configured to use the corresponding meaning that is derived subsequent to execution of the particular task to form an archival record that comprises, at least in part, the corresponding meaning.
